(19) United States
(12) Patent Application Publication
(10) Pub. No.: US 2026/0023387 A1
(43) Pub. Date: Jan. 22, 2026

(54) ROBOT CONTROL APPARATUS AND METHOD THEREOF

(71) Applicants: Hyundai Motor Company, Seoul (KR); Kia Corporation, Seoul (KR)

(72) Inventors: Hwan Hee Lee, Hwaseong-si (KR); Yun Sub Kim, Hwaseong-si (KR)

(21) Appl. No.: 18/958,611

(22) Filed: Nov. 25, 2024

(30) Foreign Application Priority Data
Jul. 19, 2024 (KR) 10-2024-0095877

(51) Int. Cl. G05D 1/622; G05D 1/644; G05D 111/10; G05D 111/30

(52) U.S. Cl. CPC G05D 1/622; G05D 1/644; G05D 2111/17; G05D 2111/30

(57) ABSTRACT

A robot control apparatus and a method thereof are provided. A robot control apparatus can include a sensor and a processor. The processor can determine whether an external object and a robot will collide with each other in a first path including a target point, based on identifying the external object using the sensor, while operating the robot along the first path, and can operate the robot along a second path for avoiding a collision between the robot and the external object, based on generating the second path. The first path can include a shortest distance path for causing the robot to move to the target point.

### CROSS-REFERENCE TO RELATED APPLICATIONS

This application claims the benefit of priority to Korean Patent Application No. 10-2024-0095877, filed in the Korean Intellectual Property Office on Jul. 19, 2024, the entire contents of which are incorporated herein by reference.

### TECHNICAL FIELD

The present disclosure relates to a robot control apparatus and a method thereof.

### BACKGROUND

Recently, research on various robot technologies has been in progress in the field associated with a robot. Particularly, various studies for a technology for allowing a robot to avoid an obstacle and move have been in progress.

Research for avoiding a dynamic obstacle to reach a target point at a shortest distance, rather than simply avoiding the dynamic obstacle, if the robot avoids the dynamic obstacle, has proceeded.

### SUMMARY

The present disclosure relates to a robot control apparatus and a method thereof, and more particularly, relates to technologies for operating a robot.

An embodiment of the present disclosure can solve the above-mentioned problems occurring in the prior art while advantages achieved by the prior art are maintained intact.

An embodiment of the present disclosure can provide a robot control apparatus for predicting a movement path of an external object (e.g., an obstacle and/or a dynamic obstacle) and predicting whether a robot and the external object will collide with each other and a method thereof.

An embodiment of the present disclosure can provide a robot control apparatus for avoiding an external object, if it is predicted that a robot and the external object will collide with each other, and a method thereof.

An embodiment of the present disclosure can provide a robot control apparatus for generating an avoidance path for preventing a collision between a robot and an external object, if it is predicted that the robot and the external object will collide with each other, and a method thereof.

Technical problems to be solved by an embodiment of the present disclosure are not necessarily limited to the aforementioned problems, and solutions to other technical problems not mentioned herein by an embodiment of the present disclosure can be clearly understood from the following description by those skilled in the art to which the present disclosure pertains.

According to an embodiment of the present disclosure, a robot control apparatus may include a sensor and a processor. The processor may determine whether an external object and a robot will collide with each other in a first path including a target point, based on identifying the external object using the sensor, while operating the robot along the first path, and may operate the robot along a second path for avoiding a collision between the robot and the external object, based on generating the second path. The first path may include a shortest distance path for causing the robot to move to the target point.

In an embodiment, the processor may determine whether the external object and the robot will collide with each other in the first path, based on at least one of an identifier assigned to the external object, a type of the external object, a position of the external object, a speed of the external object, or a movement direction of the external object, or any combination thereof.

In an embodiment, the processor may identify a shortest path for avoiding the external object, based on predicting a movement path of the external object, and may generate the second path corresponding to the shortest path.

In an embodiment, the processor may generate at least one of the first path or the second path, or any combination thereof, based on at least one of a grid-based algorithm, a graph-based algorithm, or a sampling-based algorithm, or any combination thereof.

In an embodiment, the processor may segment a movement path of the external object into a plurality of first sections over a designated time, on a map including the first path, may segment the first path into second sections over the designated time, based on a speed of the robot, and may predict the collision between the external object and the robot, based on that at least one of the first sections and at least one of the second sections overlap with each other.

In an embodiment, the processor may generate a transit point to avoid the collision, based on predicting the collision, and may operate the robot along the second path including the transit point, based on generating the second path.

In an embodiment, the processor may generate the transit point for bypassing an obstacle box with an expanded size, based on expanding a size of an obstacle box corresponding to the external object, on the map.

In an embodiment, the processor may generate the transit point in a second direction opposite to a first direction including a movement direction of the external object.

In an embodiment, the processor may generate the second path, based on a first partial path connecting a starting point of the robot and the transit point and a second partial path connecting the transit point and the target point.

In an embodiment, the sensor may include a camera, light detection and ranging (LiDAR), radio detecting and ranging (RADAR), or an obstacle detection sensor, or any combination thereof.

In an embodiment, the external object may include a dynamic obstacle.

In an embodiment, the processor may obtain the second path, based a collision risk index. The collision risk index may be obtained based on an absolute value of a difference between a first index indicating a position of the external object at a point where the collision between the robot and the external object is predicted and a second index indicating a position of the robot at the point where the collision between the robot and the external object is predicted.

In an embodiment, the processor may select an object with a smallest collision risk index or an object closest to the robot, if the collision risk indexes are the same as each other, as a preferred avoidance object, based on predicting a collision between a plurality of external objects including the external object and the robot, and may generate a third path for avoiding a collision between the robot and the preferred avoidance object, based on selecting the preferred avoidance object.

According to an embodiment of the present disclosure, a robot control method may include determining, by a processor, whether an external object and a robot will collide with each other in a first path including a target point, based on identifying the external object using a sensor, while operating the robot along the first path, and operating, by the processor, the robot along a second path for avoiding a collision between the robot and the external object, based on generating the second path. The first path may include a shortest distance path for causing the robot to move to the target point.

The robot control method according to an embodiment may further include determining whether the external object and the robot will collide with each other in the first path, based on at least one of an identifier assigned to the external object, a type of the external object, a position of the external object, a speed of the external object, or a movement direction of the external object, or any combination thereof.

The robot control method according to an embodiment may further include identifying a shortest path for avoiding the external object, based on predicting a movement path of the external object, and generating the second path corresponding to the shortest path.

The robot control method according to an embodiment may further include generating at least one of the first path or the second path, or any combination thereof, based on at least one of a grid-based algorithm, a graph-based algorithm, or a sampling-based algorithm, or any combination thereof.

The robot control method according to an embodiment may further include segmenting a movement path of the external object into a plurality of first sections over a designated time, on a map including the first path, segmenting the first path into second sections over the designated time, based on a speed of the robot, and predicting the collision between the external object and the robot, based on that at least one of the first sections and at least one of the second sections overlap with each other.

The robot control method according to an embodiment may further include generating a transit point to avoid the collision, based on predicting the collision, and operating the robot along the second path including the transit point, based on generating the second path.

The robot control method according to an embodiment may further include generating the transit point for bypassing an obstacle box with an expanded size, based on expanding a size of an obstacle box corresponding to the external object, on the map.

The robot control method according to an embodiment may further include generating the transit point in a second direction opposite to a first direction including a movement direction of the external object.

The robot control method according to an embodiment may further include generating the second path, based on a first partial path connecting a starting point of the robot and the transit point and a second partial path connecting the transit point and the target point.

In an embodiment, the sensor may include a camera, light detection and ranging (LiDAR), radio detecting and ranging (RADAR), or an obstacle detection sensor, or any combination thereof.

In an embodiment, the external object may include a dynamic obstacle.

The robot control method according to an embodiment may further include obtaining the second path, based a collision risk index. The collision risk index may be obtained based on an absolute value of a difference between a first index indicating a position of the external object at a point where the collision between the robot and the external object is predicted and a second index indicating a position of the robot at the point where the collision between the robot and the external object is predicted.

The robot control method according to an embodiment may further include selecting an object with a smallest collision risk index or an object closest to the robot, if the collision risk indexes are the same as each other, as a preferred avoidance object, based on predicting a collision between a plurality of external objects including the external object and the robot, and generating a third path for avoiding a collision between the robot and the preferred avoidance object, based on selecting the preferred avoidance object.

### BRIEF DESCRIPTION OF THE DRAWINGS

The above and other features and advantages of example embodiments of the present disclosure will be more apparent from the following detailed description taken in conjunction with the accompanying drawings, in which:

FIG. 1 illustrates an example of a block diagram associated with a robot control apparatus according to an embodiment of the present disclosure;

FIG. 2 illustrates an example of identifying a collision between a robot and an external object, in an embodiment of the present disclosure;

FIG. 3 illustrates an example of generating a path including a transit point, in an embodiment of the present disclosure;

FIG. 4 illustrates an example of a flowchart associated with a robot control method according to an embodiment of the present disclosure;

FIG. 5 illustrates an example of a flowchart associated with a robot control method according to an embodiment of the present disclosure; and

FIG. 6 illustrates a computing system associated with a robot control apparatus or a robot control method according to an embodiment of the present disclosure.

### DETAILED DESCRIPTION OF ILLUSTRATIVE EMBODIMENTS

Hereinafter, some example embodiments of the present disclosure will be described in detail with reference to the drawings. In adding reference numerals to the components of each drawing, it can be noted that identical components can be designated by identical numerals even when they are displayed in different drawings. In addition, a detailed description of well-known features or functions can be ruled out to not unnecessarily obscure the gist of the present disclosure.

In describing components of example embodiments of the present disclosure, the terms “first,” “second,” “A,” “B,” “(a),” “(b),” and the like, may be used herein. Such terms can be used merely to distinguish one component from another component, and do not necessarily limit the corresponding components irrespective of the order or priority of the corresponding components. Furthermore, unless otherwise defined, terms including technical and scientific terms used herein can have a same meaning as being generally understood by those skilled in the art to which the present disclosure pertains. Such terms as those defined in a generally used dictionary can be interpreted as having meanings equal to a contextual meaning in the relevant field of art, and are not to be interpreted as having ideal or excessively formal meanings unless clearly defined as having such in the present application.

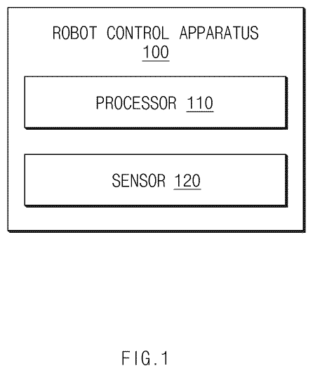

Hereinafter, example embodiments of the present disclosure will be described in detail with reference to FIGS. 1 to 6.

FIG. 1 illustrates an example of a block diagram associated with a robot control apparatus according to an embodiment of the present disclosure.

Referring to FIG. 1, a robot control apparatus 100 according to an embodiment of the present disclosure may be implemented inside and/or outside a robot, and some of the components included in the robot control apparatus 100 may be implemented inside and/or outside the robot. The robot control apparatus 100 may be integrally configured with control units in the robot and/or may be implemented as a separate device to be connected with the control units of the robot by a separate connection. For example, the robot control apparatus 100 may further include components that are not shown in FIG. 1.

The robot control apparatus 100 according to an embodiment may include a processor 110 and a sensor 120. The processor 110 and the sensor 120 may be electronically or operably coupled with each other by an electronic component including a communication bus.

Hereinafter, that pieces of hardware are operably coupled with each other may include that a direct connection or an indirect connection between the pieces of hardware is established wired or wirelessly, such that second hardware can be controlled by first hardware among the pieces of hardware.

The different blocks are illustrated, but an embodiment is not necessarily limited thereto. For example, some of the pieces of hardware of FIG. 1 may be included in a single integrated circuit including a system on a chip (SoC). Types of the pieces of hardware included in the robot control apparatus 100 and/or the number of the pieces of hardware are/is not necessarily limited to those shown in FIG. 1. For example, the robot control apparatus 100 may include only some of the pieces of hardware shown in FIG. 1.

The robot control apparatus 100 according to an embodiment may include hardware for processing data based on one or more instructions. The hardware for processing the data may include the processor 110.

For example, the hardware for processing the data may include an arithmetic and logic unit (ALU), a floating point unit (FPU), a field programmable gate array (FPGA), a central processing unit (CPU), and/or an application processor (AP), or any combination thereof. The processor 110 may have a structure of a single-core processor or may have a structure of a multi-core processor including a dual core, a quad core, a hexa core, or an octa core.

The robot control apparatus 100 according to an embodiment may include the sensor 120 for detecting an external object. For example, the robot control apparatus 100 may include the sensor 120 for identifying a surrounding environment of a robot including the robot control apparatus 100.

For example, the sensor 120 may include at least one of a camera, light detection and ranging (LiDAR), radio detecting and ranging (RADAR), an obstacle detection sensor, or any combination thereof.

For example, the processor 110 may identify the surrounding environment of the robot including the robot control apparatus 100, using sensor data obtained by use of the sensor 120. For example, the processor 110 may identify an external object in the surrounding environment of the robot including the robot control apparatus 100, using the sensor data obtained by use of the sensor 120. For example, the external object may include a dynamic obstacle.

The processor 110 of the robot control apparatus 100 according to an embodiment may operate the robot along a first path including a target point. For example, the processor 110 may operate the robot along the first path facing the target point. For example, the first path may include a shortest distance path for causing the robot to move to the target point.

In an embodiment, while operating the robot along the first path including the target point, the processor 110 may identify an external object using the sensor 120. For example, the external object may be referred to as an obstacle.

For example, while operating the robot along the first path including the target point, the processor 110 may determine whether the external object and the robot will collide with each other in the first path, based on identifying the external object using the sensor 120.

For example, the processor 110 may identify at least one of an identifier assigned to the external object, a type of the external object, a position of the external object, a speed of the external object, or a movement direction of the external object, or any combination thereof. For example, the processor 110 may identify the at least one of the identifier assigned to the external object, the type of the external object, the position of the external object, the speed of the external object, or the movement direction of the external object, or the any combination thereof, based on the sensor data obtained by use of the sensor 120.

For example, the processor 110 may determine whether the external object and the robot will collide with each other in the first path, based on the at least one of the identifier assigned to the external object, the type of the external object, the position of the external object, the speed of the external object, or the movement direction of the external object, or the any combination thereof.

In an embodiment, the processor 110 may generate at least one of the first path or a second path, or any combination thereof, based on at least one of a grid-based algorithm, a graph-based algorithm, or a sampling-based algorithm, or any combination thereof.

For example, the grid-based algorithm and/or the graph-based algorithm may include at least one of an A* algorithm, a Dijkstra algorithm, or a jump point search (JPS) algorithm, or any combination thereof. For example, the sampling-based algorithm may include a rapidly-exploring random tree (RRT).

In an embodiment, the processor 110 may generate the second path for avoiding the external object. For example, the processor 110 may operate the robot along the second path, based on generating the second path for avoiding the external object.

For example, the processor 110 may predict a movement path of the external object. For example, the processor 110 may predict the movement path of the external object, based on the sensor data obtained by use of the sensor 120. For example, the processor 110 may predict the movement path of the external object, based on the sensor data associated with the external object. For example, the processor 110 may predict the movement path of the external object, based on at least one of a speed of the external object or a movement direction of the external object, or any combination thereof.

For example, the processor 110 may identify a shortest path for avoiding the external object, based on predicting the movement path of the external object. The processor 110 may generate the second path corresponding to the shortest path, based on identifying the shortest path. For example, the processor 110 may operate the robot along the generated second path.

For example, the processor 110 may segment the movement path of the external object into a plurality of first sections over a designated time, on a map including the first path. For example, the first sections may be represented as a box with a size corresponding to the external object.

For example, the processor 110 may segment the first path into second sections over the designated time, based on the speed of the robot. For example, the second sections may be represented as a box with a size corresponding to the robot.

For example, the processor 110 may identify whether the first sections and the second sections overlap with each other. For example, the processor 110 may identify whether at least one of the first sections and at least one of the second sections overlap with each other. For example, the processor 110 may predict a collision between the external object and the robot, based on that the at least one of the first sections and the at least one of the second sections overlap with each other.

For example, the processor 110 may predict that the external object and the robot do not collide with each other, based on that the first sections and the second sections do not overlap with each other.

For example, the processor 110 may generate a transit point for avoiding the collision between the external object and the robot, based on predicting the collision between the external object and the robot. The processor 110 may operate the robot along the second path, based on generating the second path including the transit point.

For example, the processor 110 may identify an obstacle box corresponding to the external object on the map. For example, the map may include a two-dimensional (2D) planar coordinate system for representing the external object and/or the movement path of the robot.

For example, the processor 110 may expand a size of the obstacle box corresponding to the external object. The processor 110 may expand the size of the obstacle box, based on the size of the robot and the size of the obstacle box. For example, the processor 110 may expand the size of the obstacle box, based on a width of the robot, a length of the robot, a width of the obstacle box, and a length of the obstacle box.

For example, the processor 110 may generate the transit point for bypassing the obstacle box with the expanded size, based on expanding the size of the obstacle box corresponding to the external object.

For example, the processor 110 may identify a movement direction of the external object. For example, the processor 110 may identify the movement direction of the external object, based on the sensor data obtained using the sensor 120. The processor 110 may identify the transit point in a second direction opposite to a first direction including the movement direction of the external object.

For example, the processor 110 may identify a starting point of the robot. For example, the processor 110 may generate a first partial path connecting the starting point of the robot and the transit point. For example, the processor 110 may generate a second partial path connecting the transit point and the target point. For example, the processor 110 may connect the first partial path and the second partial path to generate the second path. For example, the processor 110 may generate the second path, based on the first partial path connecting the starting point of the robot and the transit point and the second partial path connecting the transit point and the target point.

For example, the processor 110 may operate the robot along the second path for avoiding the collision between the robot and the external object, based on generating the second path.

For example, the processor 110 may obtain the second path, based on a collision risk index. For example, the collision risk index may be obtained based on an absolute value of a difference between a first index indicating a position of the external object at a point where the collision between the robot and the external object is predicted and a second index indicating a position of the robot at the point where the collision between the robot and the external object is predicted.

For example, the processor 110 may select an object with a smallest collision risk index or an object closest to the robot, if the collision risk indexes are the same as each other, as a preferred avoidance object, based on predicting a collision between a plurality of external objects including the external object and the robot. For example, the processor 110 may generate a third path for avoiding a collision between the robot and the preferred avoidance object, based on selecting the preferred avoidance object.

As described above, if the collision between the robot and the external object is predicted, the robot control apparatus 100 according to an embodiment may generate the path for avoiding the external object and may operate the robot using the generated path, thus preventing an accident due to the robot.

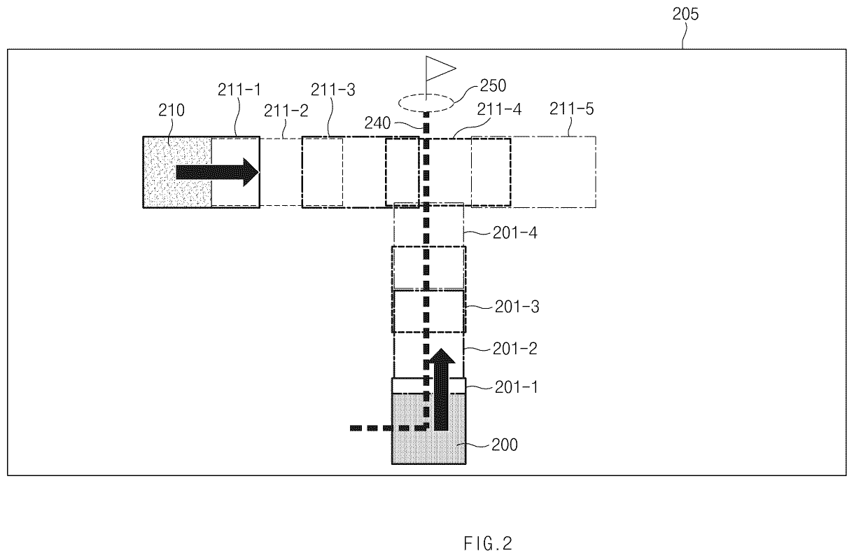

FIG. 2 illustrates an example of identifying a collision between a robot and an external object, in an embodiment of the present disclosure.

Referring to FIG. 2, a processor (e.g., a processor 110 of FIG. 1) of a robot control apparatus (e.g., a robot control apparatus 100 of FIG. 1) according to an embodiment may identify an external object 210, in a map 205 including a surrounding environment of a robot 200.

For example, the processor may identify the external object 210 located around the robot 200 using a designated algorithm. For example, the processor may detect the external object 210 by using a deep learning-based algorithm including at least one of an image processing-based algorithm, a you only look once (YOLO) algorithm, or a faster region with convolutional neural networks (R-CNN), or any combination thereof.

In an embodiment, the processor may track the external object 210, using the designated algorithm. For example, the processor may track the external object 210 by using at least one of an assignment algorithm including at least one of a Hungarian algorithm or a bipartite algorithm, the deep learning-based algorithm, or any combination thereof.

For example, the processor may identify a movement path 240 of the robot 200. For example, the processor may identify the movement path 240 including a target point 250.

For example, the processor may segment the movement path 240 into sections 201-1, 201-2, 201-3, and 201-4, based on identifying the movement path 240 of the robot 200. For example, the processor may generate the sections 201-1, 201-2, 201-3, and 201-4 in which the size of the robot 200 is reflected.

For example, the processor may segment a movement path of the external object 210 into sections 211-1, 211-2, 211-3, 211-4, and 211-5, based on identifying the movement path of the external object 210. For example, the processor may generate the sections 211-1, 211-2, 211-3, 211-4, and 211-5 in which the size of the external object 210 is reflected.

Hereinafter, to differentiate between the sections 201-1, 201-2, 201-3, and 201-4 and the sections 211-1, 211-2, 211-3, 211-4, and 211-5, the sections 201-1, 201-2, 201-3, and 201-4 are referred to as robot sections 201-1, 201-2, 201-3, and 201-4 and the sections 211-1, 211-2, 211-3, 211-4, and 211-5 are referred to as object sections 211-1, 211-2, 211-3, 211-4, and 211-5.

In an embodiment, the processor may identify whether the robot sections 201-1, 201-2, 201-3, and 201-4 and the object sections 211-1, 211-2, 211-3, 211-4, and 211-5 overlap with each other.

For example, the processor may identify whether at least one of the robot sections 201-1, 201-2, 201-3, and 201-4 and at least one of the object sections 211-1, 211-2, 211-3, 211-4, and 211-5 overlap with each other.

For example, the processor may predict whether the robot 200 and the external object 210 will collide with each other, based on whether the at least one of the robot sections 201-1, 201-2, 201-3, and 201-4 and the at least one of the object sections 211-1, 211-2, 211-3, 211-4, and 211-5 overlap with each other.

For example, the processor may predict whether the robot 200 and the external object 210 will collide with each other, based on robot section information associated with the robot sections 201-1, 201-2, 201-3, and 201-4 and object section information associated with the object sections 211-1, 211-2, 211-3, 211-4, and 211-5.

For example, the robot section information may include a position and a time of the robot 200. For example, the robot section information may include a position and a time of the external object 210. For example, the processor may predict that the robot 200 and the external object 210 will collide with each other, based on the position and the time of the robot 200 partially match the position and the time of the external object 210, in the robot section information and the object section information.

For example, the processor may predict whether the robot 200 and the external object 210 will collide with each other, based on that the at least one of the robot sections 201-1, 201-2, 201-3, and 201-4 and the at least one of the object sections 211-1, 211-2, 211-3, 211-4, and 211-5 overlap with each other.

For example, the processor may predict whether the robot 200 and the external object 210 will not collide with each other, based on that the at least one of the robot sections 201-1, 201-2, 201-3, and 201-4 and the at least one of the object sections 211-1, 211-2, 211-3, 211-4, and 211-5 do not overlap with each other.

In an embodiment, the processor may change the movement path 240 of the robot 200, based on identifying that the robot 200 and the external object 210 collide with each other. For example, the processor may change the movement path 240 of the robot 200 to avoid the collision between the robot 200 and the external object 210.

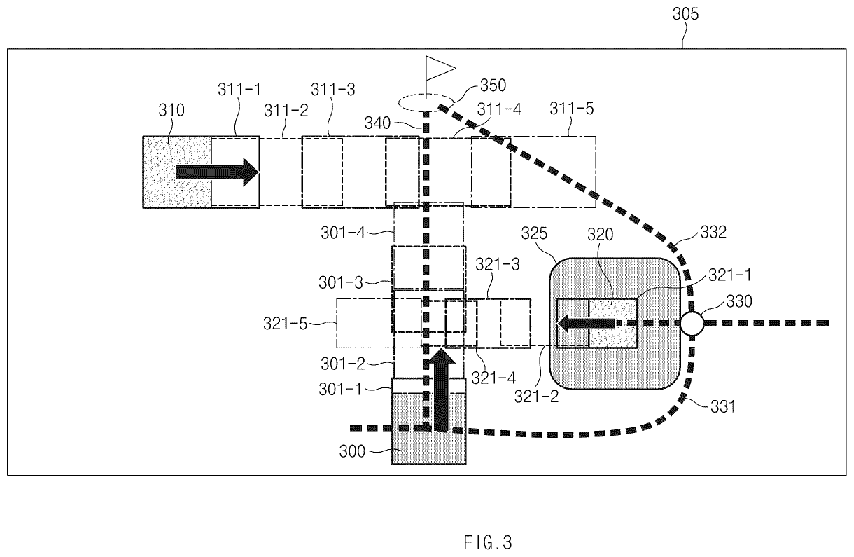

FIG. 3 illustrates an example of generating a path including a transit point, in an embodiment of the present disclosure.

Referring to FIG. 3, a processor (e.g., a processor 110 of FIG. 1) of a robot control apparatus (e.g., a robot control apparatus 100 of FIG. 1) according to an embodiment may identify a plurality of external objects 310 and 320. For example, the processor may identify the external objects 310 and 320 located around a robot 300. For example, the processor may identify the external objects 310 and 320, in a map 305 representing a surrounding environment of the robot 300.

For example, the processor may identify a movement path 340 of the robot 300 facing a target point 350.

For example, the processor may identify a movement path of the first external object 310. For example, the processor may segment the movement path of the first external object 310. For example, the processor may segment first object sections 311-1, 311-2, 311-3, 311-4, and 311-5, based on segmenting the movement path of the first external object 310.

For example, the processor may identify a movement path of the second external object 320. For example, the processor may segment the movement path of the second external object 320. For example, the processor may obtain second object sections 321-1, 321-2, 321-3, 321-4, and 321-5, based on segmenting the movement path of the second external object 320.

For example, the processor may segment the movement path 340 of the robot 300. For example, the processor may obtain robot sections 301-1, 301-2, 301-3, and 301-4, based on segmenting the movement path 340 of the robot 300.

For example, the processor may predict whether the robot 300 and at least one of the external objects 310 and 320 will collide with each other, based on at least one of the robot sections 301-1, 301-2, 301-3, and 301-4, the first object sections 311-1, 311-2, 311-3, 311-4, and 311-5, or the second object sections 321-1, 321-2, 321-3, 321-4, and 321-5, or any combination thereof.

For example, the processor may predict an object which first collides with the robot 300 among the external objects 310 and 320. In FIG. 3, the processor may predict that the second external object 320 between the first external object 310 and the second external object 320 first collides with the robot 300.

For example, the processor may adjust a size of an obstacle box corresponding to the second external object 320, based on predicting that the second external object 320 first collides with the robot 300. For example, the processor may expand the size of the obstacle box corresponding to the second external object 320. For example, the processor may generate a path for avoiding an obstacle box 325 with the expanded size, based on generating the obstacle box 325 with the expanded size.

For example, the processor may generate a transit point 330 for avoiding the obstacle box 325 with the expanded size. For example, the processor may generate the transit point 330 located in a second direction (e.g., a right direction of FIG. 3) opposite to a first direction (e.g., a left direction of FIG. 3) including a progress direction of the second external object 320.

For example, the processor may generate a path to operate the robot 300, using the transit point 330. For example, the processor may generate a first partial path 331 connecting a starting point of the robot 300 and the transit point 330. For example, the processor may generate a second partial path 332 connecting the transit point 330 and the target point 350. For example, the processor may generate a path for avoiding the second external object 320, using the first partial path 331 and the second partial path 332.

For example, if generating at least one of the first partial path 331 or the second partial path 332, or any combination thereof, the processor may use at least one of a grid-based algorithm, a graph-based algorithm, or a sampling-based algorithm, or any combination thereof. In an embodiment, the processor may generate at least one of the first partial path 331 or the second partial path 332, or any combination thereof by using at least one of the grid-based algorithm, the graph-based algorithm, or the sampling-based algorithm, or any combination thereof.

As described above, the robot control apparatus according to an embodiment may generate the path for avoiding the external objects 310 and 320 to perform safe operation of the robot 300, based on predicting whether the external objects 310 and 320 and the robot 300 will collide with each other.

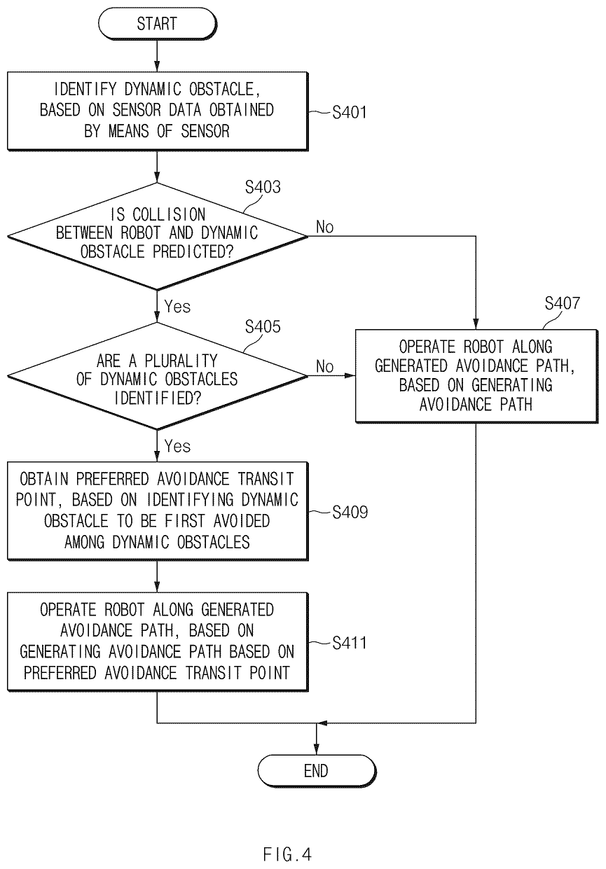

FIG. 4 illustrates an example of a flowchart associated with a robot control method according to an embodiment of the present disclosure.

Hereinafter, a robot control apparatus 100 of FIG. 1 can perform a process of FIG. 4. Furthermore, in a description of FIG. 4, an operation described as being performed by an apparatus may be understood as being controlled by a processor 110 of the robot control apparatus 100.

At least one of the operations of FIG. 4 may be performed by the robot control apparatus 100 of FIG. 1. At least one of the operations of FIG. 4 may be controlled by the processor 110 of FIG. 1. The respective operations of FIG. 4 may be sequentially performed, but are not necessarily sequentially performed. For example, an order of the respective operations may be changed, and at least two operations may be performed in parallel.

Referring to FIG. 4, in operation S401, the robot control method according to an embodiment may include identifying a dynamic obstacle, based on sensor data obtained by use of a sensor.

For example, the robot control method may include obtaining the sensor data, based on at least one of a camera, LiDAR, RADAR, or an obstacle detection sensor, or any combination thereof. For example, the robot control method may include identifying the dynamic obstacle, based on obtaining the sensor data by using the at least one of the camera, the LiDAR, the RADAR, or the obstacle detection sensor, or the any combination thereof. For example, the dynamic obstacle may include the external object described with reference to FIGS. 1 to 3.

In operation S403, the robot control method according to an embodiment may include determining whether a collision between a robot and the dynamic obstacle is predicted.

For example, the robot control method may include determining whether the collision between the robot and the dynamic obstacle is predicted, based on a movement path of the robot and a movement path of the dynamic obstacle.

For example, the robot control method may include predicting whether the robot and the dynamic obstacle will collide with each other, based on robot sections obtained by segmenting the movement path of the robot and obstacle sections obtained by segmenting the movement path of the dynamic obstacle.

For example, the robot control method may include predicting whether the robot and the dynamic obstacle will collide with each other, based on a number assigned to the robot sections and a number assigned to the obstacle sections. For example, the number assigned to the robot sections may include information associated with sections corresponding to a position of the robot as the robot moves and a time when it is predicted that each of the sections will reach the position. For example, the number assigned to the obstacle sections may include information associated with sections corresponding to a position of the dynamic obstacle as the dynamic obstacle moves and a time when it is predicted that each of the sections will reach the position.

If the collision between the robot and the dynamic obstacle is predicted (Yes in operation S403), in operation S405, the robot control method according to an embodiment may include determining whether a plurality of dynamic obstacles are identified.

For example, the robot control method may include determining whether there are the plurality of dynamic obstacles in the movement path of the robot, if the collision between the robot and the dynamic obstacle is predicted.

If the collision between the robot and the dynamic obstacle is not predicted (No in operation S403) or if the plurality of dynamic obstacles are not identified (No in operation S405), in operation S407, the robot control method according to an embodiment may include operating the robot along a generated avoidance path, based on generating the avoidance path.

If the plurality of dynamic obstacles are identified (Yes in operation S405), in operation S409, the robot control method according to an embodiment may include obtaining a preferred avoidance transit point, based on identifying a dynamic obstacle to be first avoided among the dynamic obstacles.

For example, the robot control method may include identifying a dynamic obstacle predicted to first collide with the robot among the plurality of dynamic obstacles. For example, the robot control method may include obtaining the preferred avoidance transit point for avoiding the dynamic obstacle predicted that it will first collide with the robot.

In operation S411, the robot control method according to an embodiment may include operating the robot along a generated avoidance path, based on generating the avoidance path based on the preferred avoidance transit point.

For example, the robot control method may include identifying a current position of the robot. For example, the robot control method may include obtaining a first partial avoidance path connecting the current position of the robot and the preferred avoidance transit point.

For example, the robot control method may include obtaining a second partial avoidance path connecting the preferred avoidance transit point and the target point.

For example, the robot control method may include obtaining the avoidance path, based on the first partial avoidance path and the second partial avoidance path.

For example, the robot control method may include operating the robot along the avoidance path generated based on the first partial avoidance path and the second partial avoidance path.

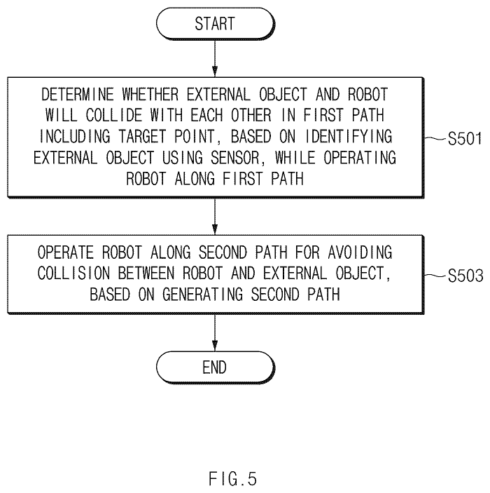

FIG. 5 illustrates an example of a flowchart associated with a robot control method according to an embodiment of the present disclosure.

Hereinafter, a robot control apparatus 100 of FIG. 1 can perform a process of FIG. 5. Furthermore, in a description of FIG. 5, an operation described as being performed by an apparatus may be understood as being controlled by a processor 110 of the robot control apparatus 100.

At least one of the operations of FIG. 5 may be performed by the robot control apparatus 100 of FIG. 1. At least one of the operations of FIG. 5 may be controlled by the processor 110 of FIG. 1. The respective operations of FIG. 5 may be sequentially performed, but are not necessarily sequentially performed. For example, an order of the respective operations may be changed, and at least two operations may be performed in parallel.

Referring to FIG. 5, in operation S501, the robot control method according to an embodiment may include determining whether an external object and a robot will collide with each other in a first path including a target point, based on identifying the external object using a sensor, while operating the robot along the first path.

For example, the robot control method may include determining whether the external object and the robot will collide with each other in the first path, based on the at least one of an identifier assigned to the external object, a type of the external object, a position of the external object, a speed of the external object, or a movement direction of the external object, or any combination thereof.

For example, the robot control method may include segmenting a movement path of the external object into a plurality of first sections over a designated time, on a map including the first path. For example, the robot control method may include segmenting the first path into second sections over the designated time, based on a speed of the robot.

For example, the robot control method may include predicting a collision between the external object and the robot, based on that at least one of the first sections and at least one of the second sections overlap with each other.

In operation S503, the robot control method according to an embodiment may include operating the robot along a second path for avoiding the external object, based on generating the second path.

For example, the robot control method may include identifying a movement path of the external object. For example, the robot control method may include identifying a shortest path for avoiding the external object, based on predicting the movement path of the external object. For example, the shortest path for avoiding the external object may be obtained based on a transit point which will be described below. For example, the robot control method may include generating the second path corresponding to the obtained shortest path.

For example, the robot control method may include generating at least one of the first path or the second path, or any combination thereof, based on at least one of a grid-based algorithm, a graph-based algorithm, or a sampling-based algorithm, or any combination thereof.

For example, the robot control method may include generating the second path, based on predicting the collision between the robot and the external object. For example, the robot control method may include generating a transit point to avoid the collision between the robot and the external object, based on predicting the collision. The robot control method may include generating the second path including the transit point. For example, the robot control method may include operating the robot along the second path including the transit point, based on generating the second path.

For example, the robot control method may include expanding a size of an obstacle box corresponding to the external object, on a map. For example, the robot the method may include generating the transit point for bypassing an obstacle box with an expanded size, based on expanding the size of the obstacle box corresponding to the external object.

For example, the robot control method may include generating the transit point in a second direction opposite to a first direction including the movement direction of the external object. For example, the robot control method may include generating a straight line that overlaps with the movement direction of the external object. For example, the robot control method may include generating the transit point at a position which does not overlap with the external object, based on generating the straight line that overlaps with the movement direction of the external object.

For example, the robot control method may include generating a first partial path connecting a starting point of the robot and the transit point. For example, the robot control method may include generating a second partial path connecting the transit point and the target point.

For example, the robot control method may include generating the second path, based on the first partial path and the second partial path. For example, the robot control method may include generating the second path including the first partial path and the second partial path.

As described above, the robot control method according to an embodiment may include generating the path for avoiding the external object, based on detecting the external object. The robot control method may include generating the path for avoiding the external object and controlling operation of the robot along the generated path to safely operate the robot.

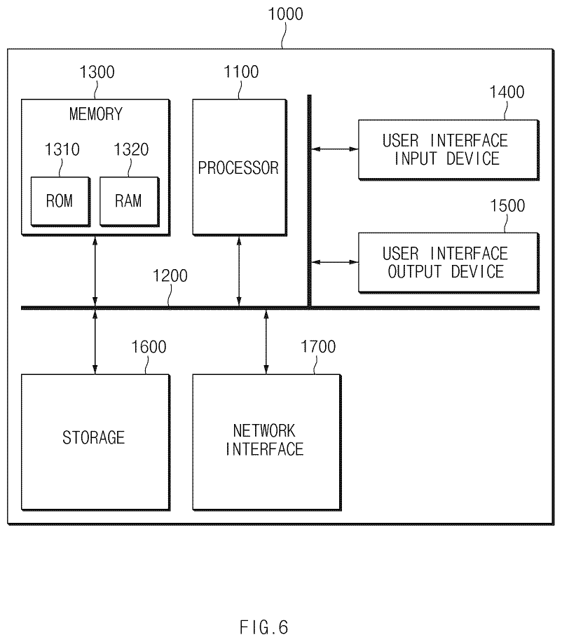

FIG. 6 illustrates a computing system associated with a robot control apparatus or a robot control method according to an embodiment of the present disclosure.

Referring to FIG. 6, a computing system 1000 may include at least one processor 1100, a memory 1300, a user interface input device 1400, a user interface output device 1500, a storage 1600, and a network interface 1700, which are connected with each other via a bus 1200, any combination of or all of which may be in plural or may include plural components thereof.

The processor 1100 may be a central processing unit (CPU) or a semiconductor device that processes instructions stored in the memory 1300 and/or the storage 1600. A storage medium may include the memory 1300 and the storage 1600, which may include various types of volatile or non-volatile storage media. For example, the memory 1300 may include a read only memory (ROM) 1310 and a random access memory (RAM) 1320.

Accordingly, the operations of the method or algorithm described in connection with the embodiments disclosed in the specification may be directly implemented with a hardware module, a software module, or a combination of the hardware module and the software module, which is executed by the processor 1100. The software module may reside on a storage medium (that is, the memory 1300 and/or the storage 1600) such as a RAM, a flash memory, a ROM, an EPROM, an EEPROM, a register, a hard disc, a removable disk, and a CD-ROM, for example.

The example storage medium may be coupled to the processor 1100. The processor 1100 may read out information from the storage medium and may write information in the storage medium. Alternatively and/or additionally, the storage medium may be integrated with the processor 1100. The processor and the storage medium may reside in an application specific integrated circuit (ASIC). The ASIC may reside within a user terminal. The processor and the storage medium may reside in the user terminal as separate components.

An embodiment using the present technology may predict a movement path of an external object (e.g., an obstacle and/or a dynamic obstacle) and may predict whether a robot and the external object will collide with each other.

An embodiment using the present technology may avoid the external object, if it is predicted that the robot and the external object will collide with each other.

An embodiment using the present technology may generate an avoidance path for preventing the collision between the robot and the external object, if it is predicted that the robot and the external object will collide with each other.

Various advantages ascertained directly or indirectly through an embodiment of the present disclosure may be provided.

Hereinabove, although the present disclosure has been described with reference to example embodiments and the accompanying drawings, an embodiment of the present disclosure is not necessarily limited thereto, and may be variously modified and altered by those skilled in the art to which the present disclosure pertains without departing from the spirit and scopes of the present disclosure claimed in the following claims.

Therefore, the example embodiments disclosed in the present disclosure are not intended to necessarily limit technical ideas of the present disclosure and are intended to describe it, and the scopes of technical ideas of the present disclosure are not necessarily limited by the example embodiments. The scopes of the present disclosure can be construed on the basis of the accompanying claims, and technical ideas within scopes equivalent to the claims can be interpreted as being included in the claims of the present disclosure.

What is claimed is:

1. A robot control apparatus, comprising:
a sensor;
at least one processor; and
a storage medium storing computer-readable instructions that, when executed by the at least one processor, enable the at least one processor to:
determine whether an external object and a robot will collide with each other in a first path including a target point, based on identifying the external object using the sensor, while operating the robot along the first path, wherein the first path includes a shortest distance path for causing the robot to move to the target point,
generate a second path different than the first path in response to determining that the robot will collide with the external object along the first path, and
operate the robot along the second path for avoiding a collision between the robot and the external object.

2. The apparatus of claim 1, wherein the instructions further enable the at least one processor to determine whether the external object and the robot will collide with each other in the first path, based on information including an identifier assigned to the external object, a type of the external object, a position of the external object, a speed of the external object, or a movement direction of the external object, or any combination thereof.

3. The apparatus of claim 1, wherein the instructions further enable the at least one processor to:
identify a shortest path for avoiding the external object, based on predicting a movement path of the external object; and
generate the second path corresponding to the shortest path.

4. The apparatus of claim 1, wherein the instructions further enable the at least one processor to generate the first path, the second path, or the first path and the second path, based on a path algorithm including a grid-based algorithm, a graph-based algorithm, or a sampling-based algorithm, or any combination thereof.

5. The apparatus of claim 1, wherein the instructions further enable the at least one processor to:
segment a movement path of the external object into first sections over a designated time, on a map including the first path;
segment the first path into second sections over the designated time, based on a speed of the robot; and
predict the collision between the external object and the robot, based on that at least one of the first sections and at least one of the second sections overlap with each other.

6. The apparatus of claim 5, wherein the instructions further enable the at least one processor to:
generate a transit point to avoid the collision, based on the predicting of the collision; and
operate the robot along the second path including the transit point, based on the generating of the second path including the transit point on the second path.

7. The apparatus of claim 6, wherein the instructions further enable the at least one processor to:
expanding a size of an obstacle box corresponding to the external object; and
generate the transit point for bypassing the obstacle box on the map.

8. The apparatus of claim 6, wherein the instructions further enable the at least one processor to generate the transit point in a second direction opposite to a first direction, wherein the first direction includes a movement direction of the external object.

9. The apparatus of claim 6, wherein the instructions further enable the at least one processor to generate the second path, based on a first partial path connecting a starting point of the robot and the transit point and a second partial path connecting the transit point and the target point.

10. The apparatus of claim 1, wherein the sensor includes a camera, a light detection and ranging (LiDAR) device, a radio detecting and ranging (RADAR) device, or an obstacle detection sensor, or any combination thereof.

11. The apparatus of claim 1, wherein the external object includes a dynamic obstacle.

12. The apparatus of claim 1, wherein the instructions further enable the at least one processor to:
obtain a collision risk index based on an absolute value of a difference between a first index indicating a first position of the external object at a point where the collision between the robot and the external object is predicted and a second index indicating a second position of the robot at the point where the collision between the robot and the external object is predicted, and
obtain the second path based the collision risk index.

13. The apparatus of claim 12, wherein the instructions further enable the at least one processor to:
wherein when the external object is instead a plurality of external objects, select a preferred avoidance object, among the plurality of external objects, being closest to the robot or having a smallest collision risk index among a group of the collision risk index of each of the plurality of external objects, based on predicting multiple collisions between the plurality of external objects and the robot; and
generate a third path to avoid the robot colliding with the preferred avoidance object, based on the selecting of the preferred avoidance object.

14. A robot control method, comprising:
identifying an external object using a sensor of a robot, while operating the robot along a first path including a target point, wherein the first path includes a shortest distance path for causing the robot to move to the target point;
determining whether the external object and the robot will collide with each other in the first path, based on the identifying of the external object using the sensor while operating the robot along the first path;
generating a second path different than the first path in response to determining that the robot will collide with the external object along the first path; and
operating the robot along the second path for avoiding a collision between the robot and the external object, based on the generating of the second path.

15. The method of claim 14, further comprising determining whether the external object and the robot will collide with each other in the first path, based on information including an identifier assigned to the external object, a type of the external object, a position of the external object, a speed of the external object, or a movement direction of the external object, or any combination thereof.

16. The method of claim 14, further comprising:
predicting a movement path of the external object;
identifying a shortest path for avoiding the external object, based on the predicting of the movement path of the external object; and
generating the second path corresponding to the shortest path.

17. The method of claim 14, further comprising generating the first path, the second path, or the first path and the second path, based on a path algorithm including a grid-based algorithm, a graph-based algorithm, or a sampling-based algorithm, or any combination thereof.

18. The method of claim 14, further comprising:
segmenting a movement path of the external object into first sections over a designated time, on a map including the first path;
segmenting the first path into second sections over the designated time, based on a speed of the robot; and
predicting the collision between the external object and the robot, based on that at least one of the first sections and at least one of the second sections overlap with each other.

19. The method of claim 18, further comprising:
generating a transit point to avoid the collision, based on the predicting of the collision; and
operating the robot along the second path including the transit point, based on the generating of the second path including the transit point on the second path.

20. The method of claim 19, further comprising:
expanding a size of an obstacle box corresponding to the external object, on the map; and
generating the transit point for bypassing the obstacle box, on the map.

21. The method of claim 19, further comprising generating the transit point in a second direction opposite to a first direction, wherein the first direction includes a movement direction of the external object.

22. The method of claim 19, further comprising generating the second path, based on a first partial path connecting a starting point of the robot and the transit point and a second partial path connecting the transit point and the target point.

23. The method of claim 14, wherein the sensor includes a camera, a light detection and ranging (LiDAR) device, a radio detecting and ranging (RADAR) device, or an obstacle detection sensor, or any combination thereof.

24. The method of claim 14, wherein the external object includes a dynamic obstacle.

25. The method of claim 14, further comprising obtaining the second path, based a collision risk index, wherein the collision risk index is obtained based on an absolute value of a difference between a first index indicating a first position of the external object at a point where the collision between the robot and the external object is predicted and a second index indicating a second position of the robot at the point where the collision between the robot and the external object is predicted.

26. The method of claim 25, further comprising:
wherein when the external object is instead a plurality of external objects, selecting a preferred avoidance object, among the plurality of external objects, being closest to the robot or having a smallest collision risk index, based on predicting multiple collisions between the plurality of external objects and the robot; and
generating a third path to avoid the robot colliding with the preferred avoidance object, based on the selecting of the preferred avoidance object.
